(19) United States
(12) Patent Application Publication
(10) Pub. No.: US 2010/0317296 A1
(43) Pub. Date: Dec. 16, 2010

(54) WIRELESS COMMUNICATION APPARATUS AND WIRELESS COMMUNICATION METHOD

(75) Inventor: Chiharu Yamazaki, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoyo (JP)

(21) Appl. No.: 12/744,919

(22) PCT Filed: Nov. 10, 2008
(86) PCT No.: PCT/JP2008/070420

§ 371 Date: Aug. 25, 2010

(30) Foreign Application Priority Data
Nov. 29, 2007 (JP) 2007-308572

(51) Int. Cl. H04B 17/00

(52) U.S. Cl. 455/67.11

(57) ABSTRACT

A wireless communication apparatus 100 according to the present invention is provided with a transmission channel coefficient calculation unit 130-1, . . . for calculating a transmission channel coefficient in a transmission frequency band by extrapolation based on a distribution of reception channel coefficients, in a frequency direction, calculated by a reception channel coefficient calculation unit 120-1, . . . , a comparison unit 160-1, . . . for comparing an absolute value of the transmission channel coefficient calculated by an absolute value calculation unit 140-1, . . . and a threshold calculated by a threshold calculation unit 150 based on the reception channel coefficients, a difference value calculation unit 155-1, . . . for calculating a difference value between the absolute value and the threshold, and a transmission channel coefficient correction unit 170-11, . . . , when the absolute value is greater than the threshold, for correcting the transmission channel coefficient based on the difference value.

### CROSS REFERENCE TO RELATED APPLICATION

This application claims priority to and the benefit of Japanese Patent Application No. 2007-308572 (filed on Nov. 29, 2007), the entire contents of which are incorporated herein by reference.

### TECHNICAL FIELD

The present invention relates to wireless communication apparatus having a plurality of antennas, and wireless communication methods for controlling wireless communication between a wireless communication apparatus having a plurality of antennas and a counterpart wireless communication apparatus.

### BACKGROUND ART

As an adaptive control of an array weight in a transmission frequency band performed by a wireless communication apparatus having a plurality of antennas, there is a method to calculate the array weight by estimating a channel coefficient in the transmission frequency band by an extrapolation process such as a linear extrapolation based on a distribution of channel coefficients in a reception frequency band in a frequency direction (for example, Patent Document 1). More specifically, when a reception channel coefficient (absolute value) changes from a point p11 to a point p12 shown in FIG. 12, it is estimated (calculated) that a transmission channel coefficient (absolute value) is at a point p13 in FIG. 12, based on the change of the reception channel coefficient.

Patent Document 1: Japanese Patent No. 3644594

### SUMMARY OF INVENTION

### Technical Problem

However, when the transmission channel coefficient is estimated by the extrapolation process according to the above conventional art, it may cause a significant difference between the transmission channel coefficient estimated and an actual transmission channel coefficient due to fluctuation conditions of the reception channel coefficient. For example, when the reception channel coefficient (absolute value) changes from a point p21 to a point p22 as shown in FIG. 13 and the transmission channel coefficient (absolute value) is estimated (calculated) to be at a point p23 in FIG. 13 based on the change of the reception channel coefficient, an actual transmission channel coefficient (absolute value) may be, however, at a point p24 in FIG. 13, which causes a significant estimation error correspondingly to a difference between the points p23 and p24 as shown in the figure.

An object of the present invention is to provide techniques (wireless communication apparatus and wireless communication methods) which improve calculation accuracy of transmission channel coefficients in a transmission frequency band when transmission channel coefficients in the transmission frequency band are calculated from reception channel coefficients in a reception frequency band, by correcting an absolute value of a transmission channel coefficient which is considered to occur with a low probability among absolute values of the transmission channel coefficients calculated.

### Solution to Problem

In order to achieve the above object, a wireless communication apparatus having a plurality of antennas according to the present invention includes: a reception channel coefficient calculation unit for calculating a reception channel coefficient in a reception frequency band, for each of the plurality of antennas; a transmission channel coefficient calculation unit for calculating a transmission channel coefficient in a transmission frequency band, for each of the plurality of antennas, by extrapolation based on a distribution of reception channel coefficients, in a frequency direction, calculated by the reception channel coefficient calculation unit; and a correction unit, when an absolute value of the transmission channel coefficient is greater than a threshold calculated based on the reception channel coefficient, for correcting the transmission channel coefficient calculated by the transmission channel coefficient calculation unit, based on a difference value between the absolute value and the threshold.

The wireless communication apparatus according to one embodiment of the present invention is characterized in further including a difference correction value calculation unit for calculating a difference correction value by multiplying the difference value by a correction coefficient, and the correction unit corrects the transmission channel coefficient calculated by the transmission channel coefficient calculation unit, by subtracting the difference correction value from the absolute value.

The wireless communication apparatus according to another embodiment of the present invention is characterized in that the correction unit corrects the absolute value while holding a phase component of the transmission channel coefficient calculated by the transmission channel coefficient calculation unit.

The wireless communication apparatus according to yet another embodiment of the present invention is characterized in further including a difference correction value calculation unit for calculating the difference correction value by multiplying the difference value by the correction coefficient and a correction ratio calculation unit for calculating a correction ratio by dividing a value, calculated by subtracting the difference correction value calculated by the difference correction value calculation unit from the absolute value, by the absolute value, and the correction unit corrects the transmission channel coefficient calculated by the transmission channel coefficient calculation unit by multiplying the transmission channel coefficient, calculated by the transmission channel coefficient calculation unit, by the correction ratio calculated by the correction ratio calculation unit.

The wireless communication apparatus according to yet another embodiment of the present invention is characterized in further including an extrapolation distance calculation unit for calculating an extrapolation distance based on the reception channel coefficient, the transmission channel coefficient and the difference value, and the correction unit corrects the transmission channel coefficient calculated by the transmission channel coefficient calculation unit based on the extrapolation distance calculated by the extrapolation distance calculation unit and the reception channel coefficient.

The wireless communication apparatus according to yet another embodiment of the present invention is characterized in further including a channel coefficient memory unit for storing reception channel coefficients in the reception frequency band, at a plurality of time points, calculated by the reception channel coefficient calculation unit for each of the plurality of antennas, and the threshold is calculated based on the reception channel coefficients at the plurality of time points stored in the channel coefficient memory unit.

The wireless communication apparatus according to yet another embodiment of the present invention is characterized in that the threshold is calculated for each of the plurality of antennas and that the correction unit corrects the transmission channel coefficient based on a result of a comparison between the threshold of each of the plurality of antennas and the absolute value of each of the plurality of antennas.

The wireless communication apparatus according to yet another embodiment of the present invention is characterized in further including a transmission power information obtain unit for obtaining transmission power information of a counterpart wireless communication apparatus and a reception channel coefficient correction unit for correcting the reception channel coefficient calculated by the reception channel coefficient calculation unit, and the reception channel coefficient correction unit corrects the reception channel coefficient calculated by the reception channel coefficient calculation unit based on the transmission power information obtained by the transmission power information obtain unit.

The wireless communication apparatus according to yet another embodiment of the present invention is characterized in being used for a system in which the transmission frequency band and the reception frequency band are different from each other.

In order to achieve the above object, a wireless communication method according to the present invention, for controlling wireless communication between a wireless communication apparatus having a plurality of antennas and a counterpart wireless communication apparatus, includes: a reception channel coefficient calculation step for calculating a reception channel coefficient in a reception frequency band, for each of the plurality of antennas; a transmission channel coefficient calculation step for calculating a transmission channel coefficient in a transmission frequency band, for each of the plurality of antennas, by extrapolation based on a distribution of reception channel coefficients, in a frequency direction, calculated at the reception channel coefficient calculation step; and a correction step, when an absolute value of the transmission channel coefficient is greater than a threshold calculated based on the reception channel coefficient, for correcting the transmission channel coefficient calculated at the transmission channel coefficient calculation step, based on a difference value between the absolute value and the threshold.

### ADVANTAGEOUS EFFECTS ON INVENTION

According to the present invention, when an absolute value of a transmission channel coefficient is greater than a threshold, the correction unit corrects the transmission channel coefficient calculated by the transmission channel coefficient calculation unit, based on a difference value calculated by the difference value calculation unit. Therefore, an absolute value of the transmission channel coefficient, which is considered to occur with a low probability among the absolute values of the transmission channel coefficient calculated, is corrected. It is thus possible to reduce a calculation error (estimation error) of the transmission channel coefficient.

Accordingly, it is possible to provide techniques (wireless communication apparatus and wireless communication methods) which improve calculation accuracy of the transmission channel coefficient in the transmission frequency band.

### BRIEF DESCRIPTION OF DRAWINGS

FIG. 1 is a block diagram illustrating a schematic constitution of a wireless communication apparatus according to a first embodiment applying a wireless communication method of the present invention;

FIG. 2 is a diagram illustrating an example of a distribution of reception channel coefficients and transmission channel coefficients in a frequency direction, for explaining a correcting operation of the transmission channel coefficient according to the first embodiment;

FIG. 3 is a block diagram illustrating a schematic constitution of a wireless communication apparatus according to a second embodiment applying the wireless communication method of the present invention;

FIG. 4 is a diagram illustrating an example of the distribution of the reception channel coefficients and the transmission channel coefficients in the frequency direction on a complex plane, for explaining the correcting operation of the transmission channel coefficient according to the second embodiment;

FIG. 5 is a block diagram illustrating a schematic constitution of a wireless communication apparatus according to a third embodiment applying the wireless communication method of the present invention;

FIG. 6 is a diagram illustrating an example of the distribution of the reception channel coefficients and the transmission channel coefficients in the frequency direction on the complex plane, for explaining the correcting operation of the transmission channel coefficient according to the third embodiment;

FIG. 7 is a block diagram illustrating a schematic constitution of a wireless communication apparatus according to a fourth embodiment applying the wireless communication method of the present invention;

FIG. 8 is a diagram illustrating an example of the distribution of the reception channel coefficients and the transmission channel coefficients in the frequency direction on the complex plane, for explaining the correcting operation of the transmission channel coefficient according to the fourth embodiment;

FIG. 9 is a block diagram illustrating a schematic constitution of a wireless communication apparatus according to a fifth embodiment applying the wireless communication method of the present invention;

FIG. 10 is a block diagram illustrating a schematic constitution of a wireless communication apparatus according to a sixth embodiment applying the wireless communication method of the present invention;

FIG. 11 is a block diagram illustrating a schematic constitution of a wireless communication apparatus according to a seventh embodiment applying the wireless communication method of the present invention;

FIG. 12 is a diagram for explaining a conventional art to estimate the transmission channel coefficient by an extrapolation process; and

FIG. 13 is a diagram for explaining a significant estimation error by the conventional art to estimate the transmission channel coefficient by the extrapolation process.

### DESCRIPTION OF EMBODIMENTS

Embodiments of the present invention will be described with reference to the accompanying drawings.

### First Embodiment

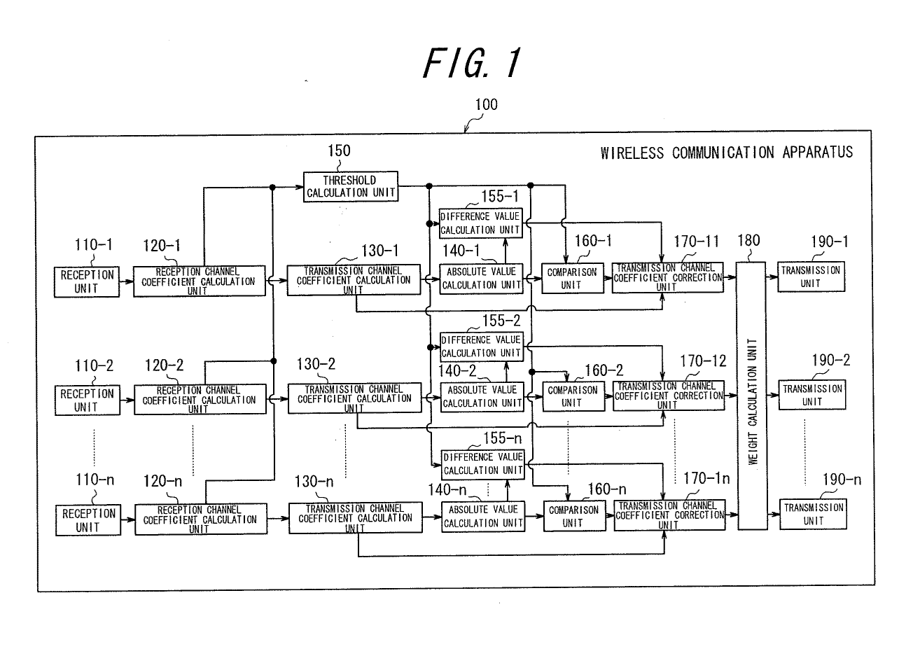

FIG. 1 is a block diagram illustrating a schematic constitution of a wireless communication apparatus according to a first embodiment applying a wireless communication method of the present invention. A wireless communication apparatus 100 according to the present embodiment is a wireless communication apparatus (hereinafter referred to also as a base station) having a plurality of antennas (not shown). The wireless communication apparatus 100 is provided with reception units 110-1 and 110-2 to 110-n for receiving radio signals transmitted from a counterpart wireless communication apparatus (not shown, hereinafter referred to also as a terminal) via the plurality of antennas, reception channel coefficient calculation units 120-1 and 120-2 to 120-n for calculating reception channel coefficients in a reception frequency band (reception channel coefficients in the reception frequency band of the respective plurality of antennas) in relation to the counterpart wireless communication apparatus based on the signals received by the reception units 110-1 and 110-2 to 110-n, transmission channel coefficient calculation units 130-1 and 130-2 to 130-n for calculating (estimating) transmission channel coefficients in a transmission frequency band (transmission channel coefficients in the transmission frequency band of the respective plurality of antennas) in relation to the counterpart wireless communication apparatus based on a distribution of the reception channel coefficients, in a frequency direction, calculated by the reception channel coefficient calculation units 120-1 and 120-2 to 120-n, absolute value calculation units 140-1 and 140-2 to 140-n for calculating absolute values of the transmission channel coefficients calculated by the transmission channel coefficient calculation units 130-1 and 130-2 to 130-n, a threshold calculation unit 150 for calculating a threshold based on the reception channel coefficients calculated by the reception channel coefficient calculation units 120-1 and 120-2 to 120-n, difference value calculation units 155-1 and 155-2 to 155-n for calculating difference values between the absolute values calculated by the absolute value calculation units 140-1 and 140-2 to 140-n and the threshold calculated by the threshold calculation unit 150, comparison units 160-1 and 160-2 to 160-n for comparing the absolute value calculated by the absolute value calculation units 140-1 and 140-2 to 140-n and the threshold calculated by the threshold calculation unit 150, transmission channel coefficient correction units 170-11 and 170-12 to 170-1n for correcting the transmission channel coefficients calculated by the transmission channel coefficient calculation units 130-1 and 130-2 to 130-n, a weight calculation unit 180 for calculating weights based on the transmission channel coefficients corrected by the transmission channel coefficient correction units 170-11 and 170-12 to 170-1n, and transmission units 190-1 and 190-2 to 190-n for transmitting the radio signals, based on the transmission channel coefficients corrected by the transmission channel coefficient correction units 170-11 and 170-12 to 170-1n and the weights calculated by the weight calculation unit 180, via the plurality of antennas.

It is to be noted that although the wireless communication apparatus (base station) of the present invention and the wireless communication method of the present invention are preferably applicable to a system in which the transmission frequency band and the reception frequency band are different from each other (for example, FDD system; Frequency Division Duplex system), the wireless communication apparatus and the wireless communication system of the present invention are not limited to the above system but applicable to other systems.

The threshold calculation unit 150 calculates a greatest absolute value, among absolute values of the reception channel coefficients calculated by the reception channel coefficient calculation units 120-1 and 120-2 to 120-n, as the threshold.

The transmission channel coefficient correction units 170-11 and 170-12 to 170-1n, when absolute values are greater than the threshold as results of comparisons by the comparison units 160-1 and 160-2 to 160-n, correct the transmission channel coefficients calculated by the transmission channel coefficient calculation units 130-1 to 130-n, based on the difference values calculated by the difference value calculation units 155-1 and 155-2 to 155-n.

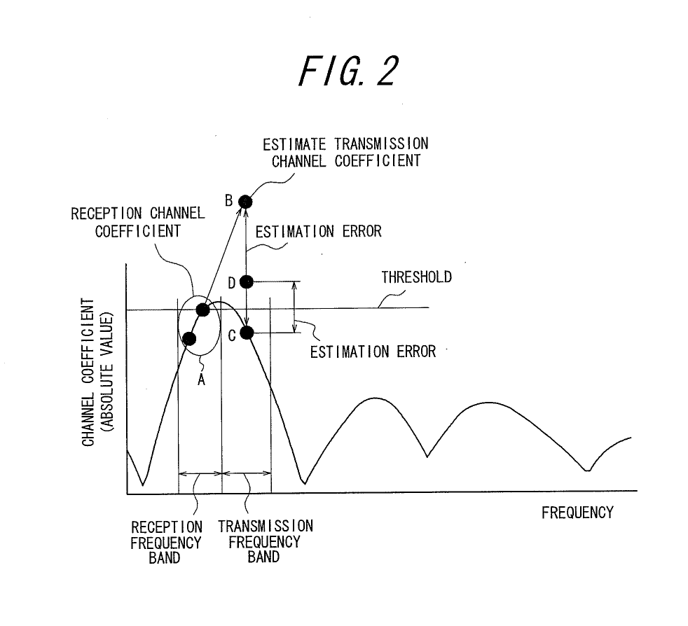

Next, a correcting operation of the transmission channel coefficient according to the first embodiment is described with reference to FIG. 2.

If there is no great change in a distance between the wireless communication apparatus (base station) 100 and the counterpart wireless communication apparatus, transmission power from the counterpart wireless communication apparatus or arrangement of the scattering objects around the wireless communication apparatus 100, there is a very low probability for the absolute value of the transmission channel coefficient greater than a certain value to occur. Whereas, when the transmission channel coefficient in the transmission frequency band is estimated (calculated) by linear extrapolation and the likes, there is “a case where a transmission channel coefficient greater than a certain absolute value is calculated (hereinafter referred to as a case 1)”, although a possibility for such a transmission channel coefficient in the transmission frequency band to be made is very low.

Such a calculation (estimation) of the transmission channel coefficient as the above case 1 means that the transmission channel coefficient in the transmission frequency band is estimated (calculated) as a point B in FIG. 2 from the distribution of the reception channel coefficients in the reception frequency band shown as a part A in FIG. 2. In this case, if a point C in FIG. 2 is a transmission channel coefficient which should be estimated originally, an estimation error between an “actual transmission channel coefficient” and an “estimated (calculated) transmission channel coefficient” corresponds to a distance between the point B and the point C, which is a significant estimation error.

As a countermeasure, the transmission channel coefficient correction units 170-11 and 170-12 to 170-1n, when transmission channel coefficients such as the point B in FIG. 2 are estimated (calculated), correct the absolute values of the transmission channel coefficients calculated by the transmission channel coefficient calculation units 130-1 and 130-2 to 130-n to a value of a point D in FIG. 2, which is located near the threshold, by decreasing the absolute values only by values approximately equal to the difference values respectively, for example, based on the difference values calculated by the difference value calculation units 155-1 and 155-2 to 155-n. Thereby, the estimation error is minimized to a distance between the point D and the point C.

The point D is determined based on accuracy of the threshold (unique to the system) which is determined according to the system configuration. Since the threshold tends to be lower than an actual threshold when having high accuracy, the point D is determined to be located at a point slightly higher than the threshold exemplified in FIG. 2. When the threshold has low accuracy, the threshold tents to be higher than the actual threshold, thus the point D is determined to be located at a point slightly lower than the threshold exemplified in FIG. 2.

According to the first embodiment, it is possible to reduce the calculation error (estimation error) of the transmission channel coefficient, by correcting the absolute value of the transmission channel coefficient, which is considered to occur with a low probability, among the absolute values of the transmission channel coefficients calculated (estimated) by extrapolation (the linear extrapolation, for example). Since the calculation error (estimation error) of the transmission channel coefficient is minimized, it is possible to improve the calculation accuracy (estimation accuracy) of the transmission channel coefficient in the transmission frequency band. Hence, it is possible to obtain good communication quality by preventing deterioration of communication quality caused by a significant difference between the uplink and downlink frequencies accompanying enhanced broadbandization of communications.

### Second Embodiment

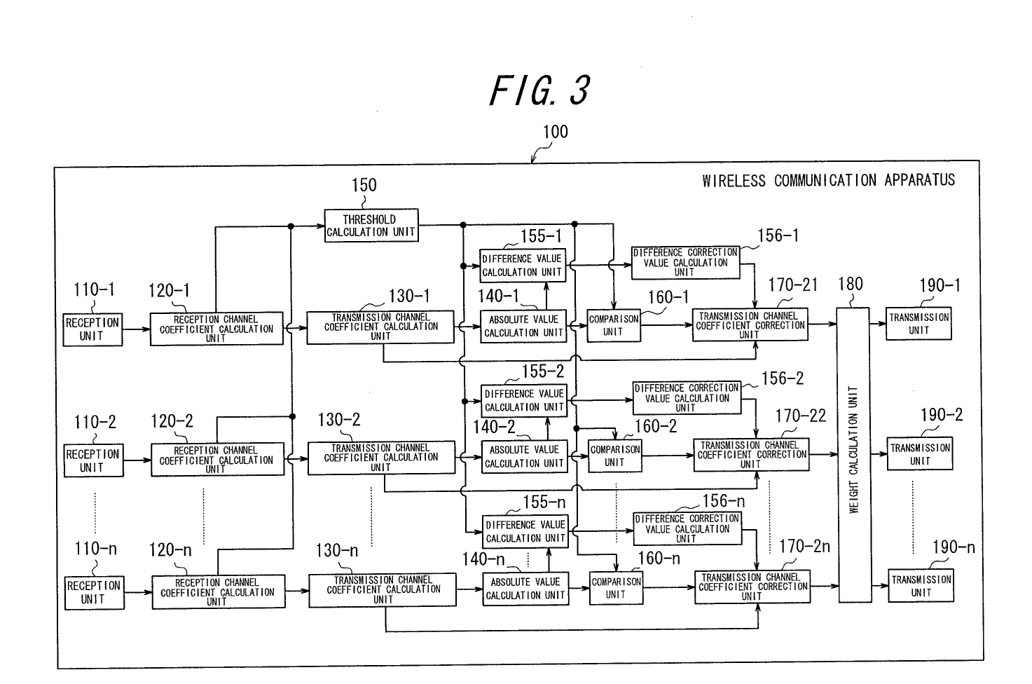

FIG. 3 is a block diagram illustrating a schematic constitution of a wireless communication apparatus according to a second embodiment applying the wireless communication method of the present invention. A wireless communication apparatus 100 according to the present embodiment has the same constitution as the wireless communication apparatus 100 of the first embodiment, except for having difference correction value calculation units 156-1 and 156-2 to 156-n in addition and replacing the transmission channel coefficient correction units 170-11 and 170-12 to 170-1n with transmission channel coefficient correction units 170-21 and 170-22 to 170-2n.

The difference correction value calculation units 156-1 and 156-2 to 156-n calculate difference correction values αB (αB1 and αB2 to αBn) by multiplying difference values B calculated by the difference value calculation units 155-1 and 155-2 to 155-n (respective difference values B1, B2 to Bn when difference values calculated by the difference value calculation unit 155-1, the difference value calculation unit 155-2 to the difference value calculation unit 155-n are referred to as B1, B2 to Bn, respectively) by a correction coefficient α. Here, the correction coefficient α may be αvalue such as 0.5, 1, 2 or the like and set to be greater as the difference value B is greater, for example.

When the absolute values are greater than the threshold as results of comparisons by the comparison units 160-1 and 160-2 to 160-n, the transmission channel coefficient correction units 170-21 and 170-22 to 170-2n correct the transmission channel coefficients calculated by the transmission channel coefficient calculation units 130-1 and 130-2 to 130-n so as to fulfill a formula (1) shown below, in other words, by subtracting the difference correction values αB (αB1 and αB2 to αBn) calculated by the difference correction value calculation units 156-1, 156-2 to 156-n from the absolute values calculated by the absolute value calculation units 140-1 and 140-2 to 140-n. At this time, the transmission channel coefficient correction units 170-21 and 170-22 to 170-2n correct the absolute values of the transmission channel coefficients while holding phase components of the transmission channel coefficients calculated by the transmission channel coefficient calculation units 130-1 and 130-2 to 130-n.

[Formula 1]

|Ĥᵢ|=|Hᵢ|−αB (1)

provided that
Ĥᵢ: complex channel coefficient after correction
| |: absolute value operation
Hᵢ: complex channel coefficient before correction
αB: a value calculated by multiplying a difference B, between the threshold and the absolute value calculated by the absolute value calculation unit, by the correction coefficient α.

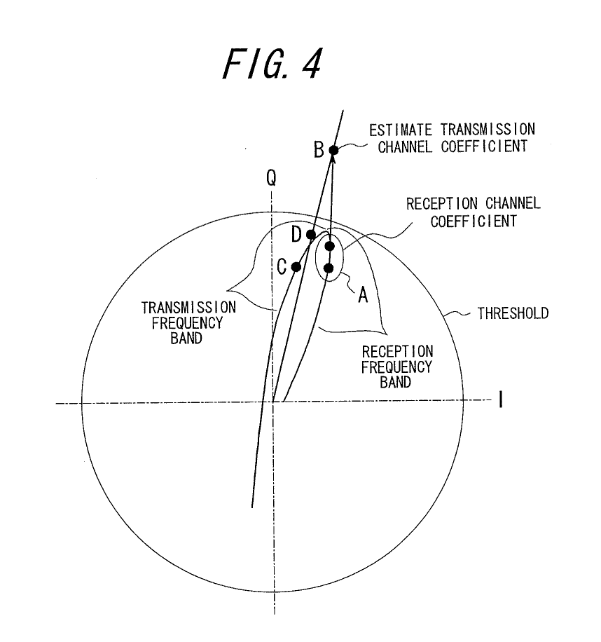

Next, the correcting operation of the transmission channel coefficient according to the second embodiment is described with reference to FIG. 4.

Such a calculation (estimation) of the transmission channel coefficient as the above case 1 means that the transmission channel coefficient in the transmission frequency band is estimated (calculated) as a point B in FIG. 4 from a distribution of the reception channel coefficients in the reception frequency band shown as a part A in FIG. 4. In this case, if a point C in FIG. 4 is a transmission channel coefficient which should be estimated originally, the estimation error between the “actual transmission channel coefficient” and the “estimated (calculated) transmission channel coefficient” corresponds to the distance between the point B and the point C, which is a significant estimation error.

As the countermeasure, the transmission channel coefficient correction units 170-21 and 170-22 to 170-2n, when transmission channel coefficients such as the point B as shown in FIG. 4 are estimated (calculated), correct the transmission channel coefficients calculated by the transmission channel coefficient calculation units 130-1 and 130-2 to 130-n (for example, correct them to a point D in FIG. 4 which is close to the threshold), by use of the formula (1) based on “the absolute values of the transmission channel coefficients and the difference correction values αB1 and αB2 to αBn calculated by the difference correction value calculation units 156-1 and 156-2 to 156-n”, while holding phase components of the transmission channel coefficients. Thereby, it is possible to minimize the estimation error to the distance between the point D and the point C. When the correction coefficient α is set to be 1 or greater, the absolute value of the transmission channel coefficient after correction falls within the threshold, while the absolute value of the transmission channel coefficient after correction becomes greater than the threshold when the correction coefficient α is set to be less than 1.

The point D is determined based on accuracy of the threshold (which is unique to the system) which is determined according to the system configuration. Since the threshold tends to be lower than the actual threshold when having high accuracy, the point D is determined to be located outside a circle of the threshold exemplified in FIG. 4. When the threshold has low accuracy, the threshold tents to be higher than the actual threshold, and thus the point D is determined to be located inside the circle of the threshold exemplified in FIG. 4.

According to the second embodiment, it is possible to reduce the calculation error (estimation error) of the transmission channel coefficient, by correcting the absolute value of the transmission channel coefficient, which is considered to occur with a low probability, among the absolute values of the transmission channel coefficients calculated (estimated) by extrapolation (the linear extrapolation, for example), in consideration of even a phase fluctuation on the channel. Since the calculation error (estimation error) of the transmission channel coefficient is minimized, it is possible to improve the calculation accuracy (estimation accuracy) of the transmission channel coefficient in the transmission frequency band. Hence, it is possible to obtain good communication quality by preventing deterioration of communication quality caused by the significant difference between the uplink and downlink frequencies accompanying enhanced broadbandization of communications.

### Third Embodiment

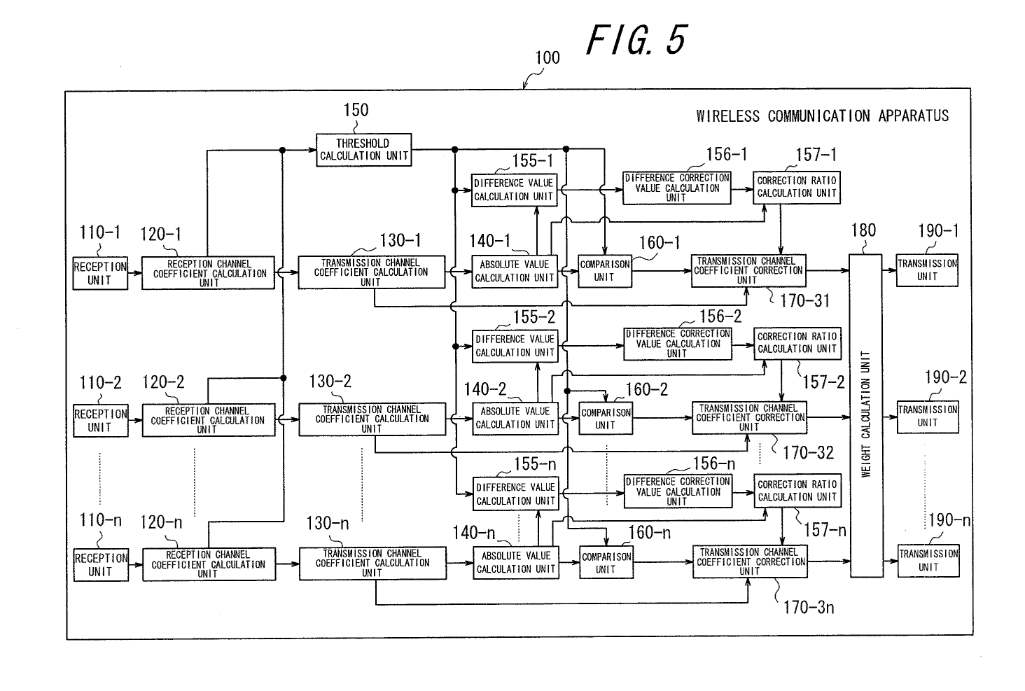

FIG. 5 is a block diagram illustrating a schematic constitution of a wireless communication apparatus according to a third embodiment applying the wireless communication method of the present invention. A wireless communication apparatus 100 according to the present embodiment has the same constitution as the wireless communication apparatus 100 of the second embodiment, except for having correction ratio calculation units 157-1 and 157-2 to 157-n in addition and replacing the transmission channel coefficient correction units 170-21 and 170-22 to 170-2n with transmission channel coefficient correction units 170-31 and 170-32 to 170-3n.

The correction ratio calculation units 157-1 and 157-2 to 157-n calculate correction ratios using the absolute values calculated by the absolute value calculation units 140-1 and 140-2 to 140-n. Particularly, the difference correction value calculation units 156-1 and 156-2 to 156-n calculate difference correction values αB (αB1 and αB2 to αBn) by multiplying difference values B calculated by the difference value calculation units 155-1 and 155-2 to 155-n (respective difference values B1, B2 to Bn when difference values calculated by the difference value calculation unit 155-1, the difference value calculation unit 155-1 to the difference value calculation unit 155-n are referred to as B1, B2 to Bn, respectively) by the correction coefficient α. Then, the correction ratio calculation units 157-1, 157-2 to 157-n subtract the difference correction values αB (αB1 and αB2 to αBn) from the absolute values and calculate correction ratios by dividing the subtracted values by the absolute values, respectively.

When the absolute values are greater than the threshold as the results of comparisons by the comparison units 160-1 and 160-2 to 160-n, the transmission channel coefficient correction units 170-31 and 170-32 to 170-3n correct the transmission channel coefficients calculated by the transmission channel coefficient calculation units 130-1 and 130-2 to 130-n using a formula (2) shown below, in other words, by multiplying the transmission channel coefficients calculated by the transmission channel coefficient calculation units 130-1 and 130-2 to 130-n by correction ratios (a right-hand side in the formula (2) except for the transmission channel coefficient Hᵢ) calculated by the correction ratio calculation units 157-1 and 157-2 to 157-n, respectively. At this time, the transmission channel coefficient correction units 170-31 and 170-32 to 170-3n correct the absolute values of the transmission channel coefficients while holding phase components of the transmission channel coefficients calculated by the transmission channel coefficient calculation units 130-1 and 130-2 to 130-n.

[Formula 2]

Ĥᵢ=Hᵢ×((|Hᵢ|−αB)/|Hᵢ|) (2)

provided that
Ĥᵢ: complex channel coefficient after correction
Hᵢ: complex channel coefficient before correction
αB: value calculated by multiplying a difference B, between the threshold and the absolute value calculated by the absolute value calculation unit, by the correction coefficient α.
| |: absolute value operation

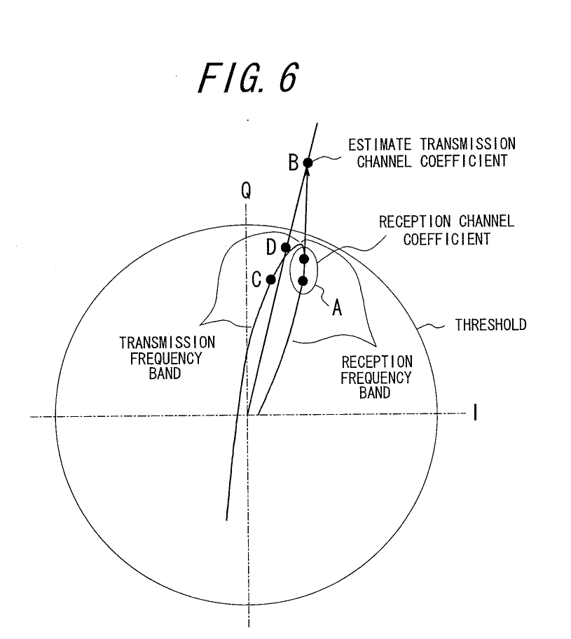

Next, the correcting operation of the transmission channel coefficient according to the third embodiment is described with reference to FIG. 6.

Such calculation (estimation) of the transmission channel coefficient as the above case 1 means that the transmission channel coefficient in the transmission frequency band is estimated (calculated) as a point B in FIG. 6 from a distribution of the reception channel coefficients in the reception frequency band shown as a part A in FIG. 6. In this case, if a point C in FIG. 6 is a transmission channel coefficient which should be estimated originally, the estimation error between the “actual transmission channel coefficient” and the “estimated (calculated) transmission channel coefficient” corresponds to the distance between the point B and the point C, which is a significant estimation error.

As the countermeasure, according to the third embodiment of the present invention to correct transmission channel coefficients as stated above, when transmission channel coefficients such as the point B in FIG. 6 are estimated (calculated), the transmission channel coefficient correction units 170-31 and 170-32 to 170-3n correct the transmission channel coefficients calculated by the transmission channel coefficient calculation units 130-1 and 130-2 to 130-n by use of the formula (2) (for example, correct them to a point D in FIG. 6 which is close to the threshold), based on “the correction ratios calculated by the correction ratio calculation units 157-1 and 157-2 to 157-n”, while holding phase components of the transmission channel coefficients. Thereby, it is possible to minimize the estimation error to the distance between the point D and the point C.

The point D is determined based on accuracy of the threshold (which is unique to the system) which is determined according to the system configuration. Since the threshold tends to be lower than an actual threshold when having high accuracy, the point D is determined to be located outside the circle of the threshold exemplified in FIG. 6. When the threshold has low accuracy, the threshold tents to be higher than the actual threshold, and thus the point D is determined to be located inside the circle of the threshold exemplified in FIG. 6.

According to the third embodiment, it is possible to reduce the calculation error (estimation error) of the transmission channel coefficient, by correcting the absolute value of the transmission channel coefficient, which is considered to occur with a low probability, among the absolute values of the transmission channel coefficients calculated (estimated) by extrapolation (the linear extrapolation, for example), in consideration of even a phase fluctuation on the channel. Since the calculation error (estimation error) of the transmission channel coefficient is minimized, it is possible to improve the calculation accuracy (estimation accuracy) of the transmission channel coefficient in the transmission frequency band. Hence, it is possible to obtain good communication quality by preventing deterioration of communication quality caused by the significant difference between the uplink and downlink frequencies accompanying enhanced broadbandization of communications.

### Fourth Embodiment

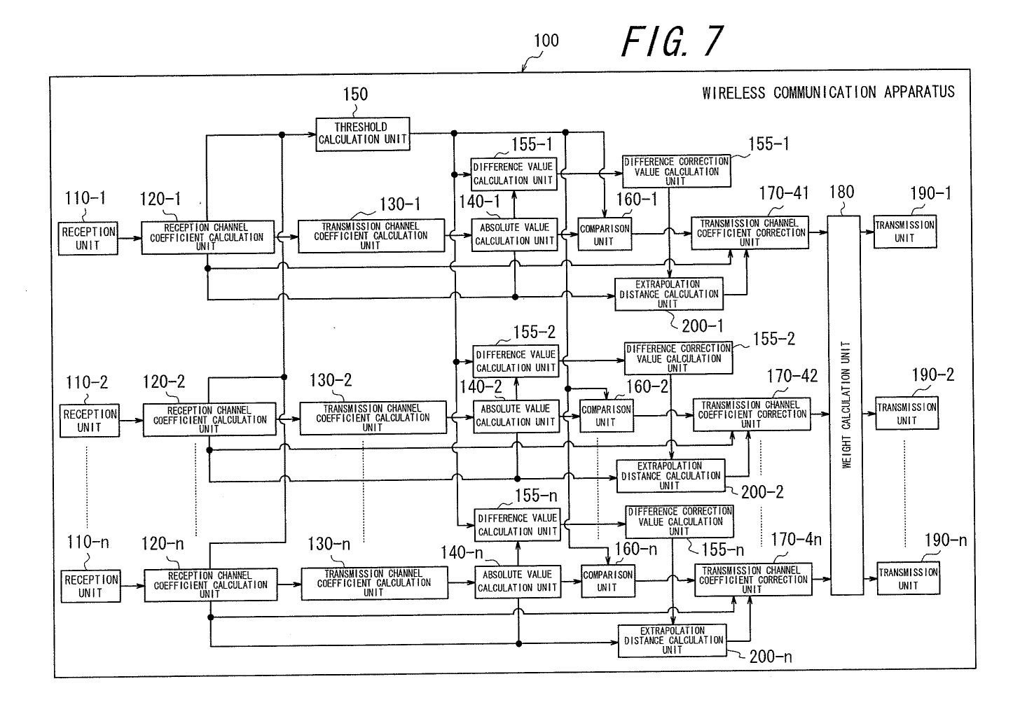

FIG. 7 is a block diagram illustrating a schematic constitution of a wireless communication apparatus according to a fourth embodiment applying the wireless communication method of the present invention. A wireless communication apparatus 100 according to the present embodiment has the same constitution as the wireless communication apparatus 100 of the second embodiment, except for having extrapolation distance calculation units 200-1 and 200-2 to 200-n in addition and replacing the transmission channel coefficient calculation units 170-21 and 170-21 to 170-2n with transmission channel coefficient correction units 170-41 and 170-41 to 170-4n.

The extrapolation distance calculation units 200-1 and 200-2 to 200-n calculate extrapolation distances so as to fulfill a formula (3) shown below based on the reception channel coefficients, the transmission channel coefficients, and the difference values.

$$[ Formula 3 ]$$

$$\vert {H}_{i} + ( L \times \frac{d {H}_{i}}{d f} ) \vert = \vert {H}_{i} \vert - α B \qquad ( 3 )$$

provided that
L: extrapolation distance
Hᵢ: complex channel coefficient in reception frequency band

$$\frac{d {H}_{i}}{d f} :$$

variation of complex channel coefficient in reception frequency band in frequency direction
| |: absolute value operation
αB: value calculated by multiplying a difference B, between the threshold and the absolute value calculated by the absolute value calculation unit, by the correction coefficient α.

When the absolute values are greater than the threshold as results of comparisons by the comparison units 160-1 and 160-2 to 160-n, the transmission channel coefficient correction units 170-41 and 170-42 to 170-4n correct the transmission channel coefficients calculated by the transmission channel coefficient calculation units 130-1 and 130-2 to 130-n using a formula (4) shown below, based on the reception channel coefficients and the extrapolation distances.

$$[ Formula 4 ]$$

$${\hat{H}}_{i} = {H}_{i} + ( L \times \frac{d {H}_{i}}{d f} ) \qquad ( 4 )$$

provided that
Ĥᵢ: complex channel coefficient after correction
Hᵢ: complex channel coefficient in reception frequency band
L: extrapolation distance calculated by extrapolation distance calculation unit

$$\frac{d {H}_{i}}{d f} \text{:}$$

variation of complex channel coefficient in reception frequency band in frequency direction

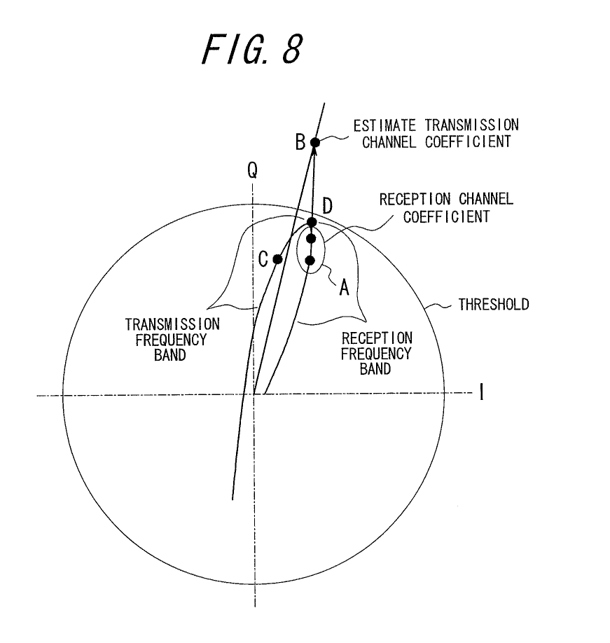

Next, the correcting operation of the transmission channel coefficient according to the fourth embodiment is described with reference to FIG. 8.

Such a calculation (estimation) of the transmission channel coefficient as the above case 1 means that the transmission channel coefficient in the transmission frequency band is estimated (calculated) as a point B in FIG. 8 from a distribution of the reception channel coefficients in the reception frequency band shown as a part A in FIG. 8. In this case, if a point C in FIG. 8 is a transmission channel coefficient which should be estimated originally, the estimation error between the “actual transmission channel coefficient” and the “estimated (calculated) transmission channel coefficient” corresponds to the distance between the point B and the point C, which is a significant estimation error.

As the countermeasure, according to the fourth embodiment of the present invention to correct the transmission channel coefficients as stated above, when transmission channel coefficients such as the point B in FIG. 8 are estimated (calculated), the transmission channel coefficient correction units 170-41 and 170-42 to 170-4n correct the transmission channel coefficients calculated by the transmission channel coefficient calculation units 130-1 and 130-2 to 130-n using the formula (4) (for example, correct them to a point D in FIG. 8 which is close to the threshold), based on “the reception channel coefficients and the extrapolation distances calculated by the extrapolation distance calculation units 200-1 and 200-2 to 200-n”, while holding phase components of the transmission channel coefficients. Thereby, it is possible to minimize the estimation error to the distance between the point D and the point C.

The point D is determined based on accuracy of the threshold (which is unique to the system) which is determined according to the system configuration. Since the threshold tends to be lower than the actual threshold when having high accuracy, the point D is determined to be located outside the circle of the threshold exemplified in FIG. 8. When the threshold has low accuracy, the threshold tents to be higher than the actual threshold, and thus the point D is determined to be located inside the circle of the threshold exemplified in FIG. 8.

According to the fourth embodiment, it is possible to reduce the calculation error (estimation error) of the transmission channel coefficient, by correcting the absolute value of the transmission channel coefficient, which is considered to occur with a low probability, among the absolute values of the transmission channel coefficients calculated (estimated) by extrapolation (the linear extrapolation, for example). Since the calculation error (estimation error) of the transmission channel coefficient is minimized, it is possible to improve the calculation accuracy (estimation accuracy) of the transmission channel coefficient. Hence, it is possible to obtain good communication quality by preventing deterioration of communication quality caused by the significant difference between the uplink and downlink frequencies accompanying enhanced broadbandization of communications.

### Fifth Embodiment

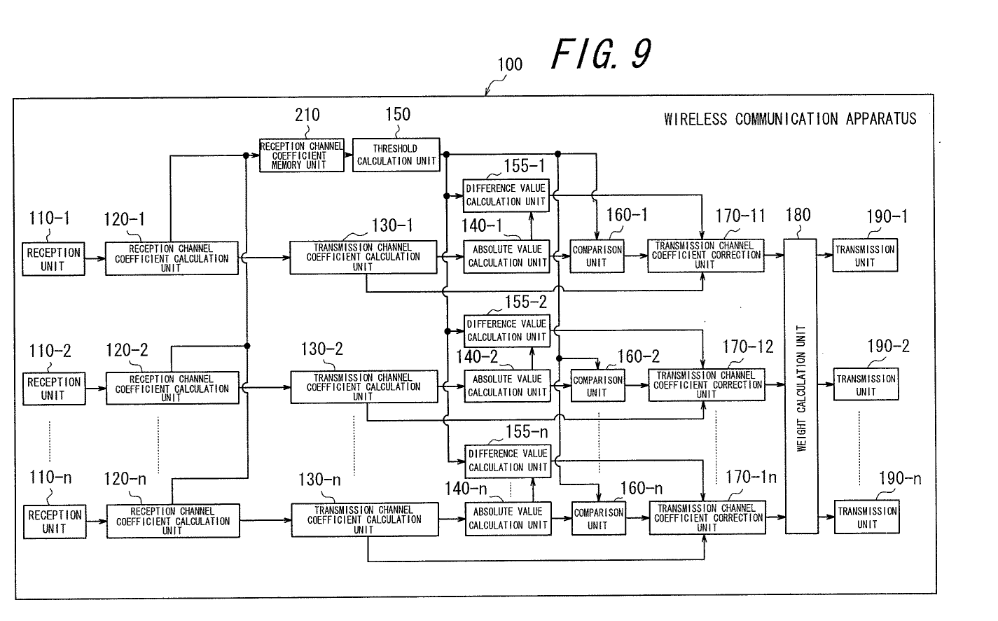

FIG. 9 is a block diagram illustrating a schematic constitution of a wireless communication apparatus according to a fifth embodiment applying the wireless communication method of the present invention. A wireless communication apparatus 100 according to the present embodiment has the same constitution as the wireless communication apparatus 100 of the first embodiment, except for having a reception channel coefficient memory unit 210 in addition.

The reception channel coefficient memory unit 210 stores the reception channel coefficients calculated by the reception channel coefficient calculation units 120-1 and 120-2 to 120-n at a plurality of time points.

The threshold calculation unit 150 calculates the maximum absolute value, among the absolute values of the reception channel coefficients at the plurality of time points stored in the reception channel coefficient memory unit 210, as the threshold.

According to the fifth embodiment, by correcting the absolute value of the transmission channel coefficient which is considered to occur with a low probability, among the absolute values of the transmission channel coefficients calculated (estimated) by extrapolation (linear extrapolation, for example), it is thus possible to reduce the calculation error (estimation error) of the transmission channel coefficient. Since the calculation error (estimation error) of the transmission channel coefficient is minimized, it is possible to improve the calculation accuracy (estimation accuracy) of the transmission channel coefficient in the transmission frequency band. Moreover, accuracy of the threshold can also be improved, as the threshold is calculated using the absolute values of the reception channel coefficients at the plurality of time points. Hence, it is possible to obtain good communication quality by preventing deterioration of communication quality caused by the significant difference between the uplink and downlink frequencies accompanying enhanced broadbandization of communications.

### Sixth Embodiment

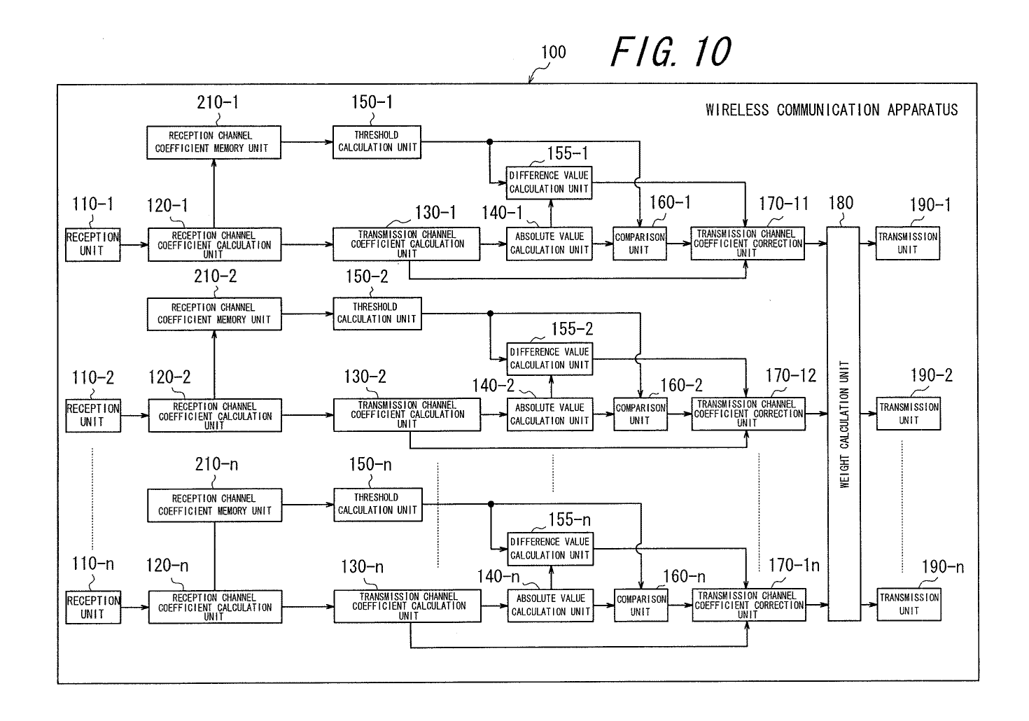

FIG. 10 is a block diagram illustrating a schematic constitution of a wireless communication apparatus according to a sixth embodiment applying the wireless communication method of the present invention. A wireless communication apparatus 100 according to the present embodiment has the same constitution as the wireless communication apparatus 100 of the fifth embodiment, except for replacing the reception channel coefficient memory unit 210 for common usage with reception channel coefficient memory units 210-1 and 210-2 to 210-n and also replacing the threshold calculation unit 150 for common usage with threshold calculation units 150-1 and 150-2 to 150-n.

Each of the reception channel coefficient memory units 210-1 and 210-2 to 210-n stores reception channel coefficients calculated by each of the reception channel coefficient calculation units 120-1 and 120-2 to 120-n at the plurality of time points.

Each of the threshold calculation units 150-1 and 150-2 to 150-n calculates the maximum absolute value, among the absolute values of the reception channel coefficients at the plurality of time points stored in each of the reception channel coefficient memory units 210-1 and 210-2 to 210-n, as the threshold.

In addition, each of the comparison units 160-1 and 160-n to 160-n compares each of the thresholds of the plurality of antennas calculated by the threshold calculation units 150-1 and 150-2 to 150-n and each of the absolute values of the transmission channel coefficients of the plurality of antennas calculated by the absolute value calculation units.

According to the sixth embodiment, by correcting the absolute value of the transmission channel coefficient which is considered to occur with a low probability, among the absolute values of the transmission channel coefficients calculated (estimated) by extrapolation (linear extrapolation, for example), it is thus possible to reduce the calculation error (estimation error) of the transmission channel coefficient. Since the calculation error (estimation error) of the transmission channel coefficient is minimized, it is possible to improve the calculation accuracy (estimation accuracy) of the transmission channel coefficient in the transmission frequency band. Moreover, accuracy of the threshold can also be improved, as the threshold is calculated using the absolute values of the reception channel coefficients at the plurality of time points. Furthermore, even when the distribution of the reception channel coefficients in relation to the counterpart wireless communication apparatus (terminal) is different for each antenna because of influence by shadowing and the likes, it is possible to correct the absolute value of the transmission channel coefficient efficiently. Hence, it is possible to obtain good communication quality by preventing deterioration of communication quality caused by the significant difference between the uplink and downlink frequencies accompanying enhanced broadbandization of communications.

### Seventh Embodiment

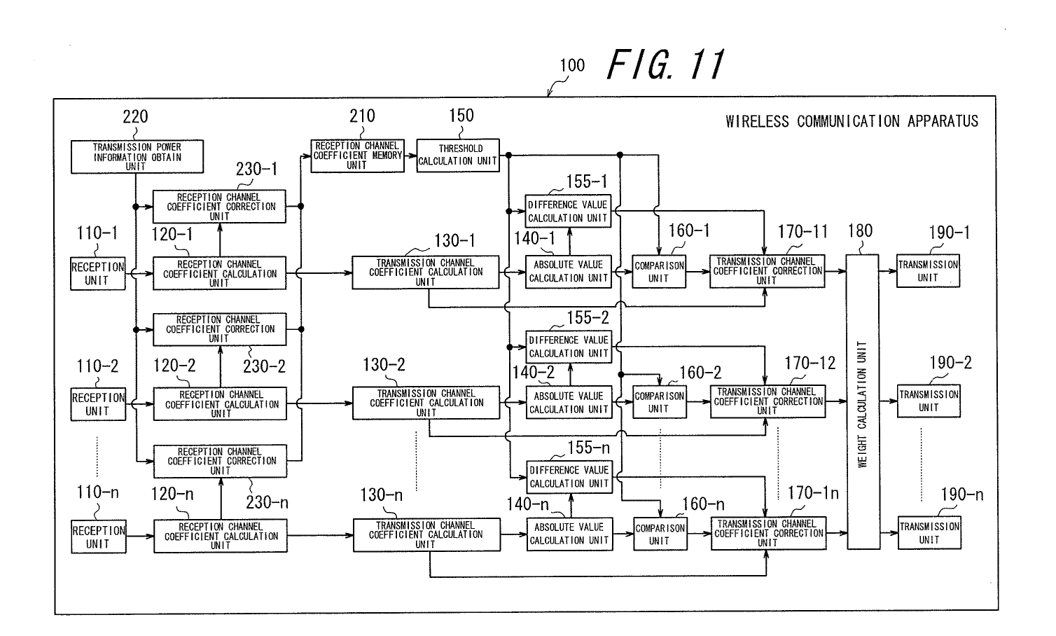

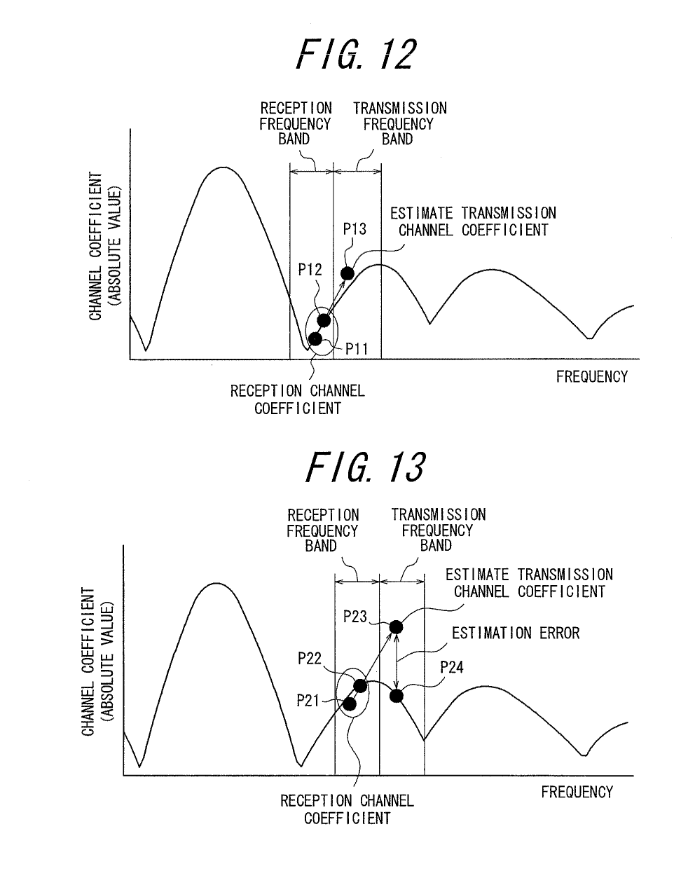

FIG. 11 is a block diagram illustrating a schematic constitution of a wireless communication apparatus according to a seventh embodiment applying the wireless communication method of the present invention. A wireless communication apparatus 100 according to the present embodiment has the same constitution as the wireless communication apparatus 100 of the first embodiment, except for having the reception channel coefficient memory unit 210, a transmission power information obtain unit 220 and reception channel coefficient correction units 230-1 and 230-2 to 230-n in addition.

The transmission power information obtain unit 220 obtains transmission power information from the counterpart wireless communication apparatus (terminal).

The reception channel coefficient correction units 230-1 and 230-1 to 230-n correct the reception channel coefficients calculated by the reception channel coefficient calculation units 120-1 and 120-2 to 120-n, based on the transmission power information obtained by the transmission power information obtain unit 220. The reception channel coefficient memory unit 210 stores the reception channel coefficients at the plurality of time points corrected by the reception channel coefficient correction units 230-1 and 230-2 to 230-n.

According to the seventh embodiment, by correcting the absolute value of the transmission channel coefficient which is considered to occur with a low probability, among the absolute values of the transmission channel coefficients calculated (estimated) by extrapolation (linear extrapolation, for example), it is thus possible to reduce the calculation error (estimation error) of the transmission channel coefficient. Since the calculation error (estimation error) of the transmission channel coefficient is minimized, it is possible to improve the calculation accuracy (estimation accuracy) of the transmission channel coefficient in the transmission frequency band. Moreover, accuracy of the threshold can also be improved, as the threshold is calculated using the absolute values of the reception channel coefficients at the plurality of time points. Furthermore, even when the transmission power of the counterpart wireless communication apparatus (terminal) changes at each of the time points or changes in the frequency direction, it is possible to correct the absolute value of the transmission channel coefficient. Hence, it is possible to obtain good communication quality by preventing deterioration of communication quality caused by the significant difference between the uplink and downlink frequencies accompanying enhanced broadbandization of communications.

It is to be understood that the thresholds calculated by the threshold calculation units 150, 150-1 and 150-2 to 150-n are not limited to “the greatest absolute value among the absolute values of the reception channel coefficients” but may be a result of addition of a predetermined value to the greatest absolute value or a result of subtraction of a predetermined value from the greatest absolute value. In addition, extrapolation used by the transmission channel coefficient calculation units 130-1 and 130-2 to 130-n for calculation of the transmission channel coefficients is not limited to “linear extrapolation” but may be other extrapolation methods. Moreover, although the transmission channel coefficients are corrected based on the absolute values calculated by the absolute value calculation units 140-1 and 140-2 to 140-n and the difference values calculated by the difference value calculation units 155-1 and 155-2 to 155-n in each of the above embodiments, it is equivalent to using the threshold(s) calculated by the threshold calculation unit(s) 150, or 150-1 and 150-2 to 150-n instead of the absolute values calculated by the absolute value calculation units 140-1 and 140-2 to 140-n if the correction coefficient α is replaced with (α-1).

1. A wireless communication apparatus having a plurality of antennas comprising:
a reception channel coefficient calculation unit for calculating a reception channel coefficient in a reception frequency band, for each of the plurality of antennas;
a transmission channel coefficient calculation unit for calculating a transmission channel coefficient in a transmission frequency band, for each of the plurality of antennas, by extrapolation based on a distribution of reception channel coefficients, in a frequency direction, calculated by the reception channel coefficient calculation unit; and
a correction unit, when an absolute value of the transmission channel coefficient is greater than a threshold calculated based on the reception channel coefficient, for correcting the transmission channel coefficient calculated by the transmission channel coefficient calculation unit, based on a difference value between the absolute value and the threshold.

2. The wireless communication apparatus according to claim 1, further comprising a difference correction value calculation unit for calculating a difference correction value by multiplying the difference value by a correction coefficient,
wherein the correction unit corrects the transmission channel coefficient calculated by the transmission channel coefficient calculation unit, by subtracting the difference correction value from the absolute value.

3. The wireless communication apparatus according to claim 1, wherein the correction unit corrects the absolute value while holding a phase component of the transmission channel coefficient calculated by the transmission channel coefficient calculation unit.

4. The wireless communication apparatus according to claim 3, further comprising a difference correction value calculation unit for calculating a difference correction value by multiplying the difference value by a correction coefficient and a correction ratio calculation unit for calculating a correction ratio by dividing a value, calculated by subtracting the difference correction value calculated by the difference correction value calculation unit from the absolute value, by the absolute value,
wherein the correction unit corrects the transmission channel coefficient calculated by the transmission channel coefficient calculation unit by multiplying the transmission channel coefficient, calculated by the transmission channel coefficient calculation unit, by the correction ratio calculated by the correction ratio calculation unit.

5. The wireless communication apparatus according to claim 1, further comprising an extrapolation distance calculation unit for calculating an extrapolation distance based on the reception channel coefficient, the transmission channel coefficient and the difference value,
wherein the correction unit corrects the transmission channel coefficient calculated by the transmission channel coefficient calculation unit based on the extrapolation distance calculated by the extrapolation distance calculation unit and the reception channel coefficient.

6. The wireless communication apparatus according to claim 1, further comprising a channel coefficient memory unit for storing reception channel coefficients in the reception frequency band, at a plurality of time points, calculated by the reception channel coefficient calculation unit, for each of the plurality of antennas,
wherein the threshold is calculated based on the reception channel coefficients at the plurality of time points stored in the channel coefficient memory unit.

7. The wireless communication apparatus according to claim 6, wherein the threshold is calculated for each of the plurality of antennas, and
the correction unit corrects the transmission channel coefficient based on a result of a comparison between the threshold of each of the plurality of antennas and the absolute value of each of the plurality of antennas.

8. The wireless communication apparatus according to claim 1, further comprising a transmission power information obtain unit for obtaining transmission power information of a counterpart wireless communication apparatus and a reception channel coefficient correction unit for correcting the reception channel coefficient calculated by the reception channel coefficient calculation unit,
wherein the reception channel coefficient correction unit corrects the reception channel coefficient calculated by the reception channel coefficient calculation unit based on the transmission power information obtained by the transmission power information obtain unit.

9. The wireless communication apparatus according to claim 1, wherein the wireless communication apparatus is used for a system in which the transmission frequency band and the reception frequency band are different from each other.

10. A wireless communication method for controlling wireless communication between a wireless communication apparatus having a plurality of antennas and a counterpart wireless communication apparatus, comprising:
a reception channel coefficient calculation step for calculating a reception channel coefficient in a reception frequency band, for each of the plurality of antennas;
a transmission channel coefficient calculation step for calculating a transmission channel coefficient in a transmission frequency band, for each of the plurality of antennas, by extrapolation based on a distribution of reception channel coefficients, in a frequency direction, calculated at the reception channel coefficient calculation step; and
a correction step, when an absolute value of the transmission channel coefficient is greater than a threshold calculated based on the reception channel coefficient, for correcting the transmission channel coefficient calculated at the transmission channel coefficient calculation step, based on a difference value between the absolute vale and the threshold.
